(19) United States
(12) Patent Application Publication
(10) Pub. No.: US 2009/0194183 A1
(43) Pub. Date: Aug. 6, 2009

(54) BLADDER AND METHOD FOR CURED-IN-PLACE PIPE LINING

(75) Inventor: LARRY W. KIEST, JR., OTTAWA, IL (US)

Correspondence Address: MCKEE, VOORHEES & SEASE, P.L.C., 801 GRAND AVENUE, SUITE 3200, DES MOINES, IA, 50309-2721, US

(73) Assignee: LMK ENTERPRISES, INC., OTTAWA, IA (US)

(21) Appl. No.: 12/026,209

(22) Filed: Feb. 5, 2008

(51) Int. Cl. F16L 55/164; F16L 55/18; B29C 63/28

(52) U.S. Cl. 138/98; 264/269; 264/516; 156/287; 138/97

(57) ABSTRACT

A fiber reinforced non-stick plastic bladder is provided. The bladder preferably includes a bladder body formed of a fiber reinforcing material layer with a coating on the bladder body made of a thermoplastic. The coating preferably has elastomeric properties and is semi-transparent. Methods of lining pipe using the new bladder are also provided.

### BACKGROUND OF THE INVENTION

The present invention relates to pipe repair. More particularly, the present invention relates to a new type of bladder and method for using same in pipeline repair.

Various systems are used for repairing damaged sewer pipes. One system which is commonly used for repairing damaged sewer pipes is called cured-in-place pipe repair. Cured-in-place pipe repair typically uses a fabric felt-type liner, impregnated with a liquid thermoset resin. When the liner is inside an existing conduit or pipe and cured or hardened it results in a one-piece continuous new pipe lining. As a part of this process, the liner is pressed outward against the pipe using an expandable bladder. This allows the resin to cure in this position, forming the liner tightly along the inside of the pipe in the damaged area, thereby creating a water tight seal and repairing the pipe. Once the resin has sufficiently cured, the bladder may be deflated and removed.

Cured-in-place technology is used to renew main sewer pipes, lateral sewer pipes as well as other types of conduits. When using cured-in-place pipe repair for renewing both main and lateral pipes, the liner is generally either pulled in place and inflated with a bladder or the liner is inverted into place and inflated with a bladder.

Such bladders are typically made from polyurethane (PU) or polyvinyl chloride (PVC). These bladders are usually constructed from a scrim (reinforced textile) that is double coated, which means the PU or PVC resin is coated on each side of the scrim thus creating the material used to make the bladders. The scrim is important as specific scrims can allow circumferential stretch and/or longitudinal stretch, yet the scrim offers substantial reinforcement resulting in a bladder that is able to confirm to pipe bends and off-set joints and even pipe diameter changes, and is still strong enough to be inflated and even allow steam to pass through the bladder to expedite the curing cycle of the thermoset resin.

It has been generally preferred that the PU or PVC coating is translucent or semi-transparent so that when the lining tube is inserted into the bladder, the installer can visually inspect the spreading of the resin that is introduced into the liner. Thus, the installer can observe whether the resin has properly spread and saturated the liner along its entire length.

However, one of the problems with these bladders is that it is generally considered necessary that only polyester resin can be used as the thermoset resin because polyester resin does not exhibit high adhesion properties. If one was to use, for example, an epoxy resin which exhibits high adhesion properties, the bladder sticks to the epoxy resin, making it difficult to remove the bladder from the cured lining. To counter this issue, polyethylene film has been placed between the liner and the bladder. The advantage of polyethylene film is that it does not stick to most materials. However, polyethylene film has low heat resistance and is not elastic like polyurethane and PVC. In the process of repairing the pipeline, steam is often passed through the bladder to cure the resin and so the bladder must be made of materials that are capable of withstanding steam temperature and the bladder must stretch to conform to pipe size changes. Therefore despite advances in the art, problems remain.

### BRIEF SUMMARY OF THE INVENTION

Therefore it is a primary object, feature, or advantage of the present invention to improve over the state of the art.

It is another object, feature, or advantage of the present invention to provide an improved bladder for use in cured-in place pipe lining.

A further object, feature, or advantage of the present invention is to provide a bladder for use in lining pipe which is economical to manufacture, durable in use and efficient in operation.

A still further object, feature, or advantage of the present invention is to provide a bladder which is translucent or semi-transparent so that an installer may visually inspect the spreading of resin.

Another object, feature, or advantage of the present invention is to provide a bladder which does not stick to resins and can be removed from a cured lining.

Yet another object, feature, or advantage of the present invention is to provide a bladder having sufficient heat resistance to withstand steam temperatures encountered in the pipe lining process.

A further object, feature, or advantage of the present invention is to provide a bladder with sufficient elasticity to conform to pipe size changes.

A further object, feature, or advantage of the present invention is to provide a bladder that is heat weldable.

A still further object, feature, or advantage of the present invention is to provide a method of lining pipe in which the bladder does not stick to resins and can be removed from a cured lining.

One or more of these and/or other objects, features or advantages of the present invention will be apparent from the specification and claims that follow.

According to one aspect of the present invention, a fiber reinforced non-stick plastic bladder is provided for use in cured-in-place pipe repair. The bladder preferably includes a bladder body formed of a fiber reinforcing material layer and a coating on the bladder body made of a thermoplastic. The coating is preferably a thermoplastic elastomer and semi-transparent.

According to another aspect of the present invention, a system for lining pipe is provided. The system includes a liner, a curable resin for impregnating the liner, and a non-stick plastic bladder for use in lining pipe. The bladder includes a bladder body formed of a fiber reinforcing material layer and a thermoplastic coating on the bladder body.

According to another aspect of the present invention, a method of lining pipe is provided. The method includes providing a liner formed from a resin absorbent material, applying a curable resin to the liner, positioning the liner in the pipe, inflating a fiber reinforced non-stick plastic bladder, forming the liner to an interior wall of the pipe, and allowing the resin to cure, thereby lining the pipe.

According to a still further aspect of the invention, a main/lateral bladder assembly for use in repairing the junction of a main pipe and a lateral pipe connected thereto is provided. The assembly includes a main bladder tube and a lateral bladder tube made from a fiber reinforced non-stick plastic bladder material.

According to another aspect of the invention, an apparatus for repairing the junction of a main pipe and a lateral pipe is provided. The apparatus includes a main bladder tube and a lateral bladder tube, a main liner member and a lateral liner tube, and a launcher device. The lateral bladder tube is a fiber reinforced non-stick plastic bladder. The main bladder tube may be similarly constructed.

### BRIEF DESCRIPTION OF THE DRAWINGS

FIG. 1 is a pictorial cut away view representation illustrating a cured-in-place lining application where a lateral sewer pipe is lined through a cleanout pipe.

FIG. 2 is an isometric view of a liner assembly capable of being used at a pipe junction between two sewer lines.

FIG. 3 is a cutaway view of a partial liner before being inverted into a sewer line.

FIG. 4 is a cutaway view of a liner inserted into a main sewer line after inversion.

FIG. 5 is a perspective view of one embodiment of a liner/bladder assembly.

FIG. 6 is another perspective view of the liner/bladder assembly of FIG. 5.

FIG. 7 is a sectional view of one embodiment of a bladder.

### DETAILED DESCRIPTION OF THE PREFERRED EMBODIMENT

For a better understanding of the invention, several examples of forms of the invention will now be described in detail. Frequent reference will be made to the accompanying figures. Reference numerals will be used to indicate certain parts or locations in the figures. The same reference numerals will be used to indicate the same or similar parts or locations throughout the figures unless otherwise indicated.

The present invention relates to an improved bladder and method for using same in pipe repairs. The bladder is formed from a fiber reinforced non-stick plastic material, which is preferably a scrim reinforcing fabric coated with a translucent or semi-transparent thermoplastic elastomer, such as thermoplastic polyolefin (TPO) or vulcanizate (TPV). This structure of the bladder provides various advantages as will be discussed later herein. The bladder may be used in various types of pipeline repairs, including main line repairs, lateral line repairs, and repairs at pipe junctions between lines.

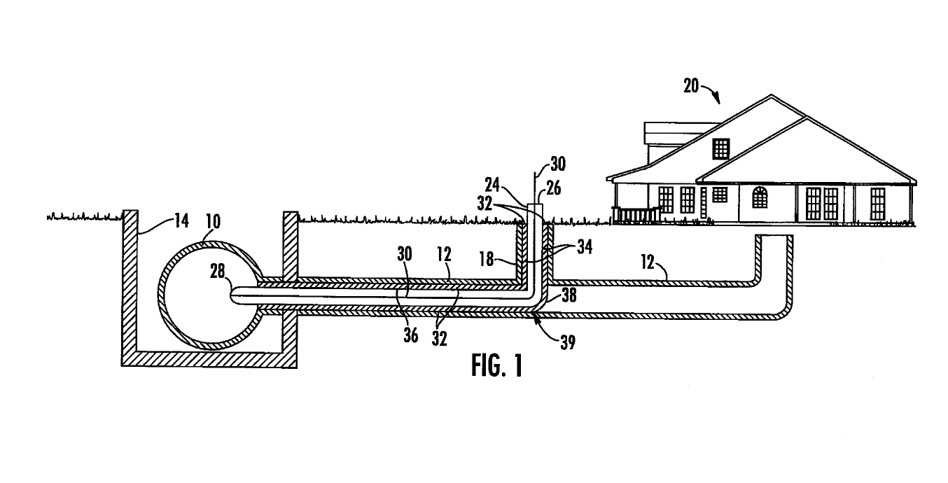

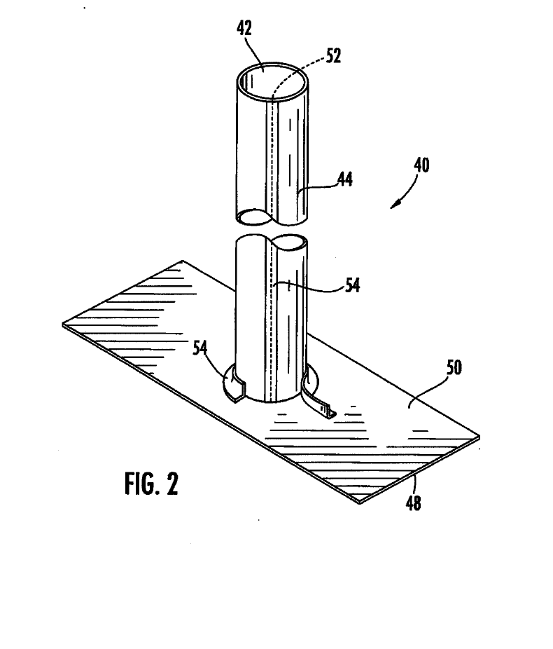

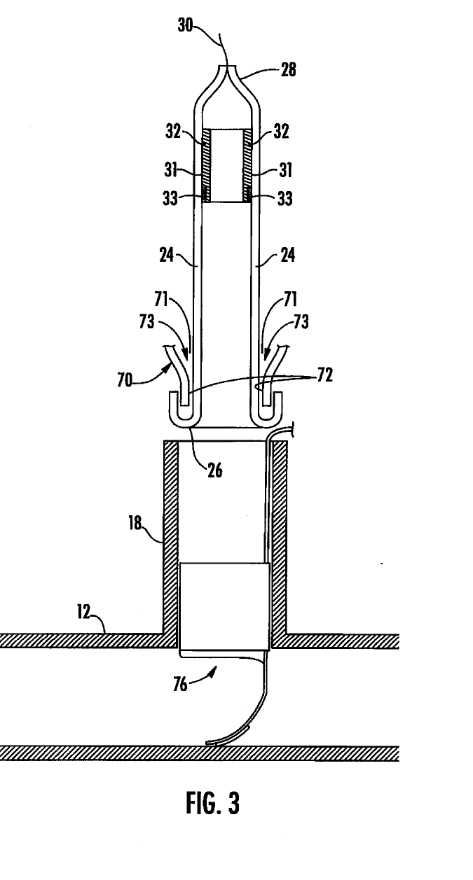

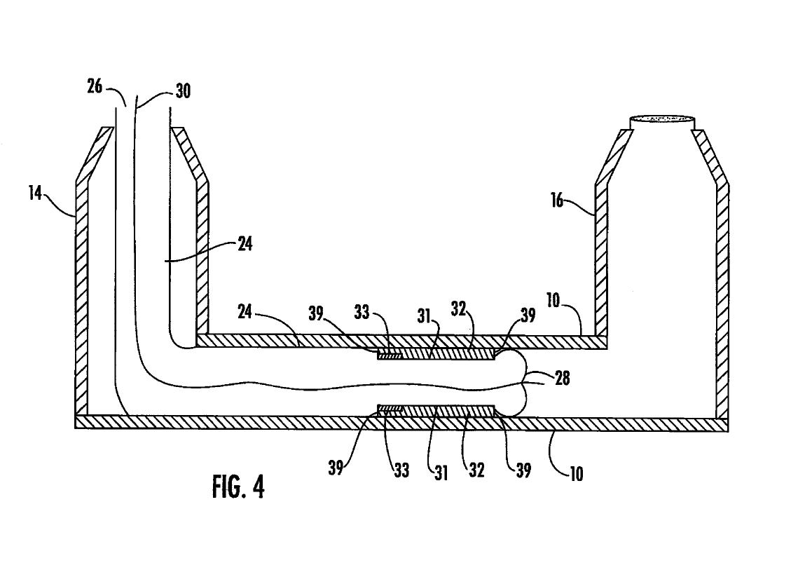

To assist in describing the invention, FIG. 1 through FIG. 4 show various types or methods of pipeline repairs performed using the bladder, including pulled-in-place methods and inversion methods. It is to be understood, however, that the present invention is not to be limited to the specific examples shown here. In particular, FIG. 1 shows a continuous liner 32 from the insertion point of the access or cleanout pipe 18 through the lateral pipe 12 to the main sewer pipe 10. FIG. 2 shows a liner assembly used for repairing pipe junctions at a main sewer line 10/lateral sewer line 12 junction or at a lateral sewer line 12/cleanout 18 junction. FIG. 3 shows one method for inserting a liner tube 32 into a partial section of lateral pipe 12 using an air pressure driven inversion process. Other types of positioning devices (not shown) can also be used to locate the liner 30 inside the pipe 10, 12 as would readily be understood by those skilled in the art. FIG. 4 shows a liner tube 32 curing in place to repair a partial section of a lateral pipe 12.

In FIG. 1, a main sewer line 10 is connected to a lateral sewer line 12 inside a manhole 14. Generally, an access pipe/cleanout 18 allows access to the lateral sewer line 12 and the main sewer line 10 without having to dig up the earth or compromise the sewer lines 10, 12. The lateral sewer line 12 extends to a house 20, giving access to the main sewer line 10 from the house 20. A pulled-in place liner requires two access points. One access point is a manhole 14, which is commonly located in public streets. The other access point may be another manhole 16 (as shown in FIG. 4), or it can also be a clean-out pipe 18, as shown in FIG. 1. The liner 32 is pulled from one access point toward the second access point using a rope or other means until the liner 32 is properly positioned in the damaged pipe.

The inversion method requires only one access point. It is generally considered a superior method for inverting a liner 32, allowing the liner 32 to be inserted into the pipe from only one access point, and allowing resin to contact the pipe directly and migrate into broken areas of the pipe without damaging the liner. However, inverting a full continuous liner 32 through a clean-out pipe 18 and into the lateral line 12 creates an upstream side which blocks off service from the house 20 through the main sewer line 10, as shown in FIG. 1. This is because the liner is within both the clean-out pipe 18 and the lateral pipe 12, blocking out the lateral pipe 12 at 38. Therefore, the lining 32 will need to be cut out at 38 after the resin is cured to reinstate service to the house 20. One can prevent the lining from blocking off service to the house 20 by locating the liner 32 within the bladder 24 such that the liner 32 does not begin to invert until it extends sufficiently within the lateral pipe 12. This is more fully described in pending application Ser. No. 11/359,026, the contents of which are incorporated herein.

The repair in FIG. 1 shows a bladder/liner assembly having a bladder 24, an open end or upper end of the bladder 26, and a closed end or lower end of the bladder 28. A pull line 30 is attached to the closed end 28 of the bladder 24 for use in removing the bladder 24 once the resin has cured. FIG. 3 shows that a liner 32 is inserted into a bladder 24 before inversion. Also, the liner 32 may have a polymer or other type of coating 31. The liner 32 is then positioned on the exterior of the bladder 24 after inversion. As can be seen from the FIG. 3, the liner 32 includes an access portion 34 of the liner 32 within the access pipe 18 and a lateral portion 36 of the liner 32 within the lateral line pipe 12.

Another type of liner assembly 40 is shown in FIG. 2. This type of liner assembly 40 is used at T-type and Y-type junctions to repair the junction of the pipe near the junction. The liner assembly 40 includes a tubular lateral liner 42 connected to a flat sheet liner member 48 that preferably rolls around onto itself forming a tube prior to installation. The flat sheet liner member 48 can alternatively form a collar about the end of the lateral liner 42. Both liners 42 and 48 are generally formed of felt or other resin absorbent material. Once liner assembly 40 has been completed, the liner 40 is moved into place in the sewer line 10, 12, 18 by any method which works to properly locate the liner assembly 40 inside the pipe junction, such as those described in U.S. Pat. No. 6,039,079.

A quantity of curable liquid resin is introduced onto the liner assembly 40 and covers the liner assembly 40 and completely impregnates the liner assembly 40. A bladder is inserted into the liner assembly 40 and expanded while the resin is allowed to cure. Thus, the liner assembly 40 takes the shape of the pipe 10, 12, 18 to fix or cover the junction or any damaged areas.

FIG. 3 and FIG. 4 show examples of inverting a liner 32 into a pipe 10, 12, 18. One having ordinary skill in the art would understand how the inversion process works to insert a liner 32 into a pipe 10, 12, 18. An external launcher 70 (shown as partial) is utilized outside the access pipe/clean out 18. The external launcher 70 has a launcher chamber 71 and a launcher opening 72. Air pressure, shown as arrows 73, is injected into the launcher chamber 71 for causing an inversion of the bladder 24 and the liner 32. A guide tool assembly 76 may be used to help direct the bladder 24 and the liner 32 to travel in the proper direction into the lateral pipe 12.

Using the inversion method of inserting the liner, preferably the liner has a thin coating 31 on the outside of the liner 32, 40 which contacts the inside of the bladder 24 when the liner 32, 40 is located inside the bladder 24 for inversion. FIG. 3 and FIG. 4 show that the liner may be frangibly attached at 33 to the bladder 24 to allow the liner 32 to travel with the bladder 24 to the desired location.

The inversion process inverts the bladder 24 and the liner 32, 40 inside the pipe 10, 12, 18. Thus, the outside or the polymer coating 31, 44, 50 before the inversion becomes the inside of the liner 32, 40 after inversion. This is best shown in FIG. 3 and FIG. 4. The bladder 24 is inflated so the liner 32, 40 is pressed against the inside of the pipe 10, 12, 18 during curing of the resin. The pull line 30 is then pulled after the resin cures to break the frangible connection 33 and remove the bladder 24.

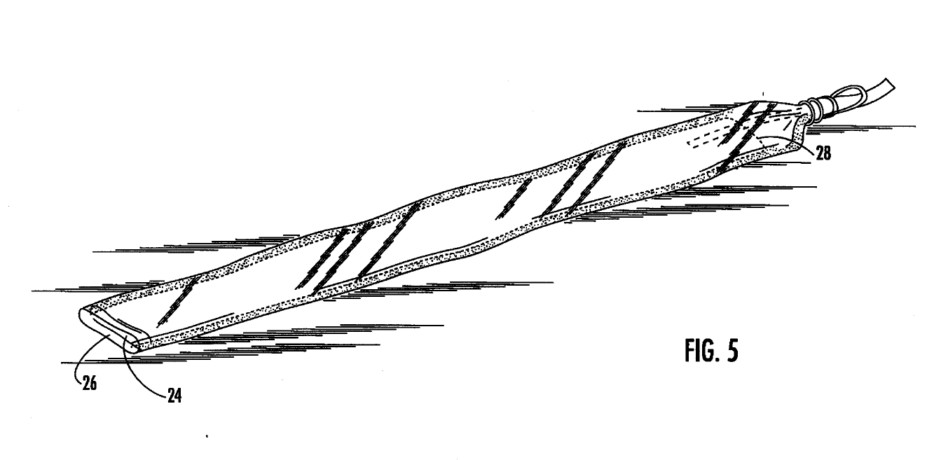

FIG. 5 is a perspective view of one embodiment of a liner/bladder assembly 70 for use in an inversion lining process. The liner/bladder assembly includes a bladder 24 having a rear end 72 and a forward end 74. Fitted within the rear end 72 is a threaded receptacle 76 which is held in place in attachment to the rear end 72 by means of clamps 78. A pulling loop 80 is also held by clamps 78 and is attached to a bladder control line 30, as shown in FIG. 4.

Within the bladder 24 is a liner 84 formed of felt or other resin absorbent material. The liner 84 is attached at its forward end to an inversion collar 88 by means of stitches or other suitable means. The forward end of the inversion collar 88 is fixedly attached to the forward end 74 of the bladder tube 24 by heat sealing, adhesive, or other suitable securing means. The stitches are easily broken away so as to permit the forward end of the liner 84 to be separated from the rear end of the inversion collar 88 by tension forces.

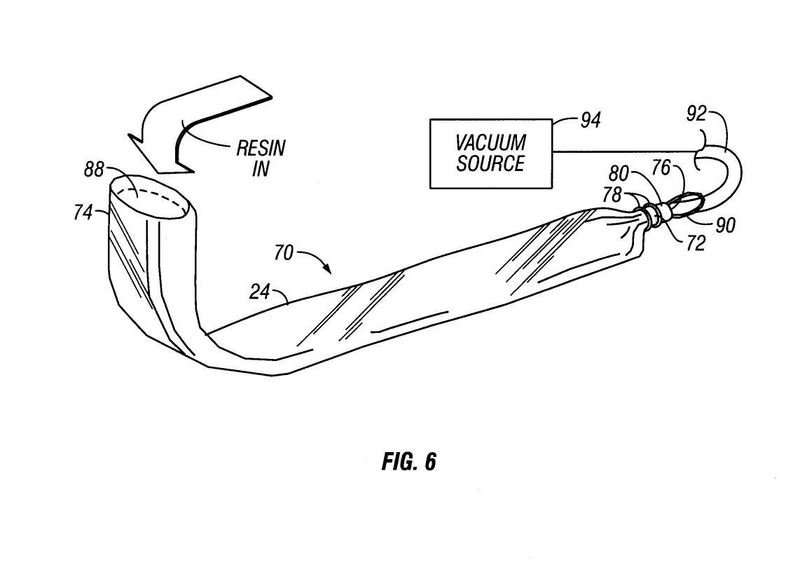

Referring to FIG. 6, a vacuum coupler 90 includes a threaded end adapted to thread within the threaded receptacle 76 so as to connect a vacuum hose 92 and a vacuum source 94 to the bladder 24. A wick 96 includes a forward end 97 located forwardly of the rear end 96 of the liner 84. The wick 96 (see FIG. 5) extends rearwardly therefrom to a rear end 98 located adjacent the threads of threaded receptacle 76.

The method of impregnating the liner 84 with resin involves pouring the resin into the forward end 74 of the bladder 24 as illustrated in FIG. 6. A quantity of resin sufficient impregnate the liner 84 is poured into the bladder 24. A vacuum is applied to the vacuum hose 92 so as to cause the bladder 24 to collapse in a flattened state. The wick 96 permits gases within the bladder 24 to be withdrawn as the bladder 24 is collapsed, including the area between the rear end 100 of the liner 84 and the rear end 72 of the bladder 24. The flattening of the bladder 24 causes the resin to be pressed rearwardly from the forward end until it has completely impregnated the felt or other resin absorbent material of the liner 84. Rollers (not shown) may also be applied to the flattened bladder 24 to facilitate the spread of resin to all portions of the liner 84. Forming the bladder 24 of a translucent or semi-transparent material permits visual observation of the progress of the resin as it is spread through the liner 84.

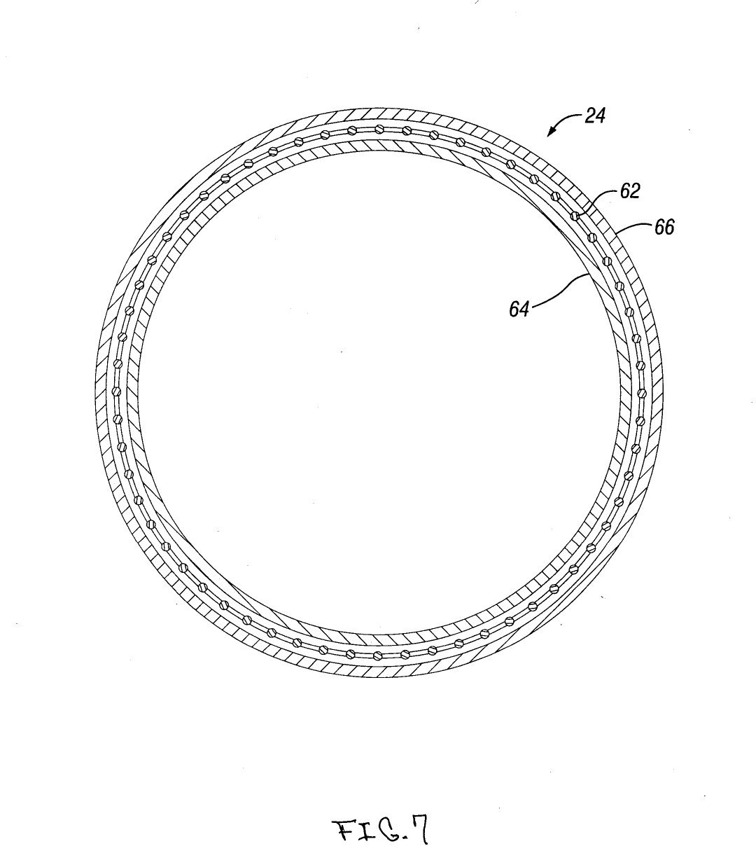

A cross-sectional view of the bladder 24 is also shown in FIG. 7. The bladder 24 has a bladder body 62 which is formed from a layer of fiber reinforcing material, such as a scrim reinforcing fabric. The layer of fiber reinforcing material is preferably a scrim of Nylon monofilament knit fibers. The bladder body 62 has an inside coating 64 and an outside coating 66. Both the inside coating 64 and the outside coating 66 preferably are formed from a translucent or semi-transparent thermoplastic elastomer (TPE), such as elastomeric thermoplastic polyolefin (TPO) or vulcanizate (TPV). Polyolefin blends and elastomeric alloys are particularly suitable for use with the present invention. An example of a commercial TPE elastomer alloy found suitable is Santoprene® from Monsanto. The wall thickness of the bladder is approximately 15-30 mils.

As indicated previously, a translucent bladder is preferred because it allows the installer to visually view or inspect the spreading of the resin on the liner within the bladder prior to installation. The thermoplastic material of the coating 64, 66 also can withstand high temperatures (at least the temperature of steam) and resists adhesion to thermoset resins like epoxy resin. This allows the bladder 24 to be easily removed after the liner has cured. Using a thermoplastic material also allows a sheet of bladder material to be rolled onto itself and heat welded along a longitudinal edge to form a tube. The thermoplastic material can also be heat welded to another bladder, such as in a main lateral bladder assembly. Selecting a bladder 24 with elastic properties, such as TPV, allows the bladder to easily conform to changes in internal pipe diameter.

As mentioned above, any system or method for getting the liner 32 into place within the pipe 10, 12, 18 and curing the liner 32 in place can be used. For example, the systems and methods described in U.S. Pat. Nos. 5,855,729; 5,964,249; 6,039,079 and 6,105,619 can all be used and are herein incorporated by reference in their entirety. In fact, the present invention is particularly useful as a part of an apparatus for repairing the junction between a main pipe and a lateral pipe wherein main and lateral liners are used with main and lateral bladders and a launching device. Both of the main and lateral bladders can be constructed as taught herein. Of course, the present invention is not to be limited to such systems and methods.

The invention has been shown and described above with the preferred embodiments, and it is understood that many modifications, substitutions, and additions may be made which are within the intended spirit and scope of the invention. For example, the bladder may be used with any number of types of positioning methods including where a liner is pulled-in-place or where a liner is inverted. The bladder may be used to make various types of repairs to conduits, including to main lines, lateral lines, intersections between pipes, or other repairs. These and other variations, options, and alternatives are within the intended spirit and scope of the invention.

What is claimed is:

1. A bladder for use in cured-in-place pipe repair, comprising:
a fiber reinforced non-stick plastic bladder adapted for use in cured-in-place pipe repair.

2. The bladder of claim 1 wherein the fiber reinforced non-stick plastic bladder comprises:
a bladder body formed of a fiber reinforced material layer; and
a coating on the bladder body comprised of a thermoplastic.

3. The bladder of claim 2 wherein the thermoplastic is a polyolefin.

4. The bladder of claim 2 wherein the coating is comprised of a thermoplastic elastomer.

5. The bladder of claim 4 wherein the thermoplastic elastomer is a thermoplastic polyolefin elastomer.

6. The bladder of claim 4 wherein the thermoplastic elastomer is thermoplastic vulcanizate.

7. The bladder of claim 1 wherein the fiber reinforced non-stick plastic bladder is semi-transparent.

8. The bladder of claim 2 wherein the bladder body having an inside surface and an outside surface and the coating is on both the inside surface and the outside surface of the bladder body.

9. A system for lining pipe, comprising:
a liner;
a curable resin for impregnating the liner; and
a non-stick plastic bladder for use in lining pipe, comprising:
a bladder body formed of a fiber reinforced material layer; and
a coating on the bladder body comprised of a thermoplastic.

10. The system of claim 9 wherein the thermoplastic is a polyolefin.

11. The system of claim 9 wherein the coating is comprised of a thermoplastic elastomer.

12. The system of claim 11 wherein the thermoplastic elastomer is a thermoplastic polyolefin elastomer.

13. The system of claim 11 wherein the thermoplastic elastomer is thermoplastic vulcanizate.

14. The system of claim 9 wherein the bladder is semi-transparent.

15. The system of claim 9 wherein the bladder body having an inside surface and an outside surface and the coating is on both the inside surface and the outside surface of the bladder body.

16. The system of claim 9 wherein the curable resin is an epoxy resin.

17. A method of lining a damaged section of pipe, comprising:
providing a liner formed from a resin absorbent material;
applying a curable resin to the liner;
positioning the liner in the pipe;
inflating a fiber reinforced non-stick plastic bladder;
forming the liner to an interior wall of the damaged section of pipe; and
allowing the resin to cure, thereby lining the damaged section of pipe.

18. The method of claim 17 wherein the wherein the fiber reinforced non-stick plastic bladder comprises:
a bladder body formed of a fiber reinforced material layer; and
a coating on the bladder body comprised of a thermoplastic.

19. The method of claim 18 wherein the coating is a polyolefin.

20. The method of claim 18 wherein the coating is comprised of a thermoplastic elastomer.

21. The method of claim 20 wherein the thermoplastic elastomer is a thermoplastic polyolefin elastomer.

22. The method of claim 20 wherein the thermoplastic elastomer is thermoplastic vulcanizate.

23. The method of claim 17 wherein the fiber reinforced non-stick plastic bladder is semi-transparent.

24. The method of claim 18 wherein the bladder body having an inside surface and an outside surface and the coating is on both the inside surface and the outside surface of the bladder body.

25. An apparatus for repairing the junction of a main pipe and a lateral pipe connected thereto, comprising:
a main bladder tube and a lateral bladder tube;
a main liner member having a main liner member opening and adapted to receive a curable resin;
a lateral lining tube of resin absorbent material extending from the main liner member about the main liner member opening;
a launcher device having first and second opposite ends and a launcher device opening there between;
the main bladder tube being outside and surrounding the launcher device and the lateral bladder tube extending through the launcher device opening and into the inside of the launcher device; and
the main liner member being outside and at least partially surrounding the main bladder tube and the launcher device, the lateral liner tube extending through the launcher device opening and into the inside of both the launcher device and the lateral bladder tube;
wherein lateral bladder tube is a fiber reinforced non-stick plastic bladder comprising:
a bladder body formed of a fiber reinforced material layer; and
a coating on the bladder body comprised of a thermoplastic.

26. The apparatus of claim 25 wherein the coating on the bladder body is comprised of a thermoplastic elastomer.

27. The apparatus of claim 25 wherein the thermoplastic elastomer is a thermoplastic polyolefin elastomer.

28. The apparatus of claim 27 wherein the thermoplastic elastomer is thermoplastic vulcanizate.

29. The apparatus of claim 25 wherein the lateral bladder is semi-transparent.

30. The apparatus of claim 25 wherein the bladder body having an inside surface and an outside surface and the coating is on both the inside surface and the outside surface of the bladder body.

31. The apparatus of claim 25 wherein the main bladder tube is a fiber reinforced non-stick plastic bladder.

32. The apparatus of claim 25 wherein the main bladder tube and the lateral bladder tube are fluidly connected.

32. A main/lateral bladder assembly for use in repairing the junction of a main pipe and a lateral pipe connected thereto, comprising:
a main bladder tube having a first end and an opposite second end with a main bladder tube opening there between; and
a lateral bladder tube connected to the main bladder tube about the main bladder tube opening;
wherein the main bladder tube is a fiber reinforced non-stick plastic bladder and the lateral bladder tube is a fiber reinforced non-stick plastic bladder.

33. A method of lining a damaged section of pipe having an interior wall, comprising:
providing a liner/bladder assembly including a tubular liner formed from a resin absorbent material;
providing a tubular bladder having a bladder body formed of a fiber reinforced material layer and a coating on the bladder body comprised of a thermoplastic;
inserting the liner into the bladder;
impregnating the liner with a resinous material capable of curing and hardening;
positioning the bladder with liner therein into the pipe near the damaged section of the pipe;
inflating the bladder so that the liner is pressed against the interior wall of the damaged section of pipe; and
allowing the resinous material to cure, thereby lining the damaged section of pipe.

34. The method of claim 33 wherein the liner is inserted into the bladder before the liner is impregnating with the resinous material.

35. The method of claim 34 wherein the liner is impregnated with a resinous using a vacuum source.

36. The method of claim 33 wherein the coating on the bladder is comprised of thermoplastic elastomer.

37. The method of claim 36 wherein the thermoplastic elastomer is a thermoplastic vulcanizate.

38. The method of claim 33 wherein the bladder is semi-transparent.

39. The method of claim 33 wherein the liner is pressed against the wall as the bladder with liner therein is inverted into the pipe.
